(19) United States
(12) Patent Application Publication
(10) Pub. No.: US 2012/0198113 A1
(43) Pub. Date: Aug. 2, 2012

(54) Time measurement of power button signal activation

(76) Inventors: Gregory P. Ziarnik, Houston, TX (US); Mark Piwonka, Tomball, TX (US); Louis B. Hobson, Tomball, TX (US)

(21) Appl. No.: 12/931,283

(22) Filed: Jan. 27, 2011

(51) Int. Cl. G06F 13/24

(52) U.S. Cl. 710/267

(57) ABSTRACT

Embodiments herein relate to measuring a continuous time period a power button signal is in an active state. In an embodiment, a controller is to measure the continuous time period the power button signal is in an active state, where the power button signal enters the active state when a power button is physically activated by a user to initiate a power down of a system. Further, the controller is to generate and send an interrupt to the system if the continuous time period is greater than a controller time, the interrupt having higher priority than an operating system of the system.

### BACKGROUND

Computing devices are generally shut down in a controlled manner by software installed on the computing device, which may be referred to as a software shutdown. However, computing devices may also include a hardware mechanism to force the shutdown of the computing device, such as when the software shutdown is not able to properly shutdown the computing device. For example, the software shutdown may not be available when the computing device becomes non-responsive or freezes. This hardware mechanism may be referred to, for example, as a hardware shutdown, override, power override, power button override, or variants thereof. Often, the hardware shutdown is activated by a user pressing and holding down the computing device's power button for a threshold period of time. For instance, the computing device may initiate the hardware shutdown after the power button is asserted for at least 4 seconds.

### BRIEF DESCRIPTION OF THE DRAWINGS

The following detailed description references the drawings, wherein:

FIG. 1 is a block diagram of an example controller to measure a continuous time period a power button signal is an active state;

FIG. 2 is a block diagram of another example controller to measure a continuous time period a power button signal is an active state;

FIG. 3 is a block diagram of an example computing device including the controller of FIG. 1 or 2;

FIG. 4 is a block diagram of a network system including the computing device of FIG. 3; and

FIG. 5 is a flowchart of an example method for measuring a continuous time period a power button signal is in an active state.

### DETAILED DESCRIPTION

Specific details are given in the following description to provide a thorough understanding of embodiments. However, it will be understood by one of ordinary skill in the art that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

However, the hardware shutdown may not allow for a controlled shutdown of the computing device. For example, data may not be saved or some flags may not be set. As a result, the computing device cannot be restarted or powered on remotely after the hardware shutdown, whereas the computing device can be restarted or powered on remotely after the software shutdown. Thus, where the computing device is relocated remotely, such as in an unattended kiosk, an operator of the computing device would likely have to travel to the location of the computing device in order to restart the computing device following the hardware shutdown,

For at least the reason above, in some cases, it may also be desirable to prevent the hardware shutdown from being initiated by the user pressing and holding down the computing device's power button. However, a chipset of the computing device cannot generally be configured or easily modified to remove such functionality.

Thus, as detailed above, computing devices are generally unable to be restarted or powered on remotely following a hardware shutdown. Further, computing devices are generally unable to prevent a user from initiating the hardware shutdown. A software or hardware shutdown may refer to a procedure for removing power from one or more of the computing device's components such as one or more processors or memories, like RAM or a hard disk drive. As explained above, the software shutdown may be a controlled shutdown of the computing device by software installed on the computing device, where the term software includes machine readable instructions. The hardware shutdown may be a forced shutdown of the computing device initiated by a hardware mechanism included in the computing device. The hardware shutdown is generally provided as a way to shut down the computing device when the software shutdown is not able to properly shut down the computing device, such as when the computing device becomes non-responsive or freezes. Embodiments may allow the computing device to be restarted or powered on remotely, even after the hardware shutdown and/or may prevent the initiation of the hardware shutdown.

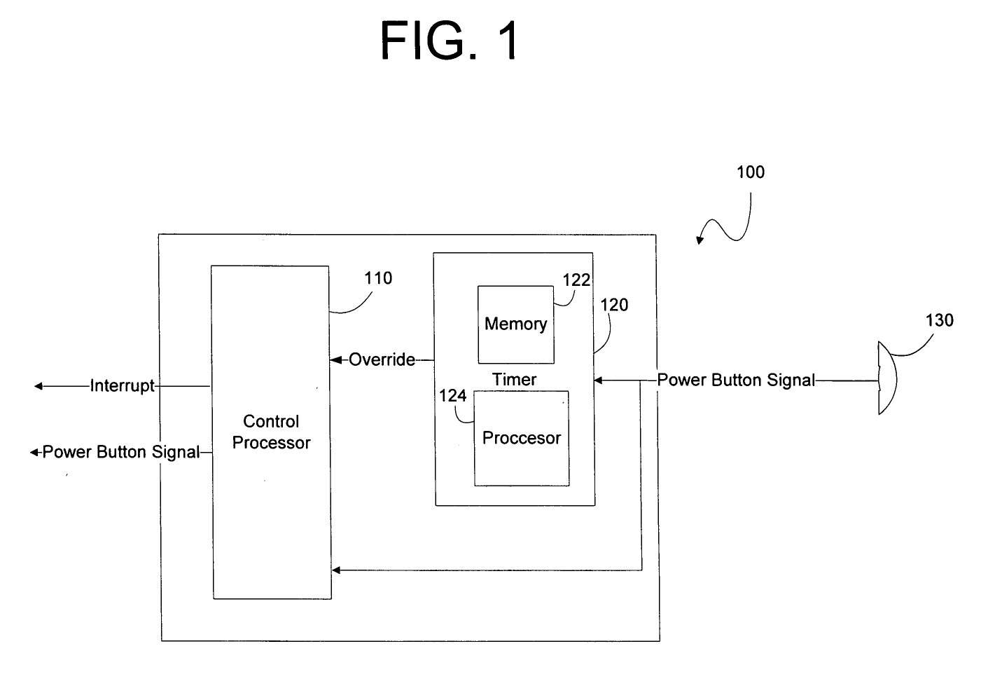

FIG. 1 is a block diagram of an example controller 100 to measure a continuous time period a power button signal is an active state. In the embodiment of FIG. 1, the controller 100 includes a control processor 110 and a timer 120. The controller 100 is to receive a power button signal from an external power button 130. In embodiments, the controller 100 may, for example, be a super Input/Output (I/O) circuit or other type of similar integrated device that supports a plurality of peripheral devices.

The term active state may refer to a signal at one of a logic high (“1”) or logic low (“0”) state. A term inactive state may refer to a signal at a remaining one of the logic high or low states or an indefinite logic state that cannot be defined as having either logic high or low. For example, a signal having a first voltage range may be determined to be logic high and a signal having a second voltage range lower than the first voltage range may be determined to be logic low. Further, a signal having any voltages outside the first and second voltage ranges may be determined to be an indefinite logic.

The timer 120 is to measure a continuous time period the power button signal is in an active state, where the power button signal enters the active state when the power button 130 is physically activated, such as by a user to initiate the hardware shutdown. If the power button signal is in a continuous active state for a time period greater than the controller time, the timer 120 is to generate and transmit an override signal in an active state to the control processor 110. Otherwise, the override signal is in an inactive state.

The controller time may be stored in a memory 122 included in the timer 120 and compared to the power button signal by a processor 124 stored in the timer 120. For example, if the controller time is 3.9 seconds, the override signal will be in an active state only if power button signal is continuously in the active state for more than 3.9 seconds. In this case, if the power button signal was in the active state for 3.8 seconds, then in the inactive state for 0.1 seconds, and next in the active state again for 3.8 seconds, the override signal would not be in the active state during this time period.

In embodiments, the controller time may also be stored externally of the timer 120, such as in the control processor 110 or elsewhere in the controller 100. Embodiments of the timer 120 may be implemented via hardware and/or software. For example, the timer 120 may be mechanical, electromechanical, electronic, software, and the like. In one embodiment, the timer may be a count-down counter that measures time based on a frequency of a clock signal.

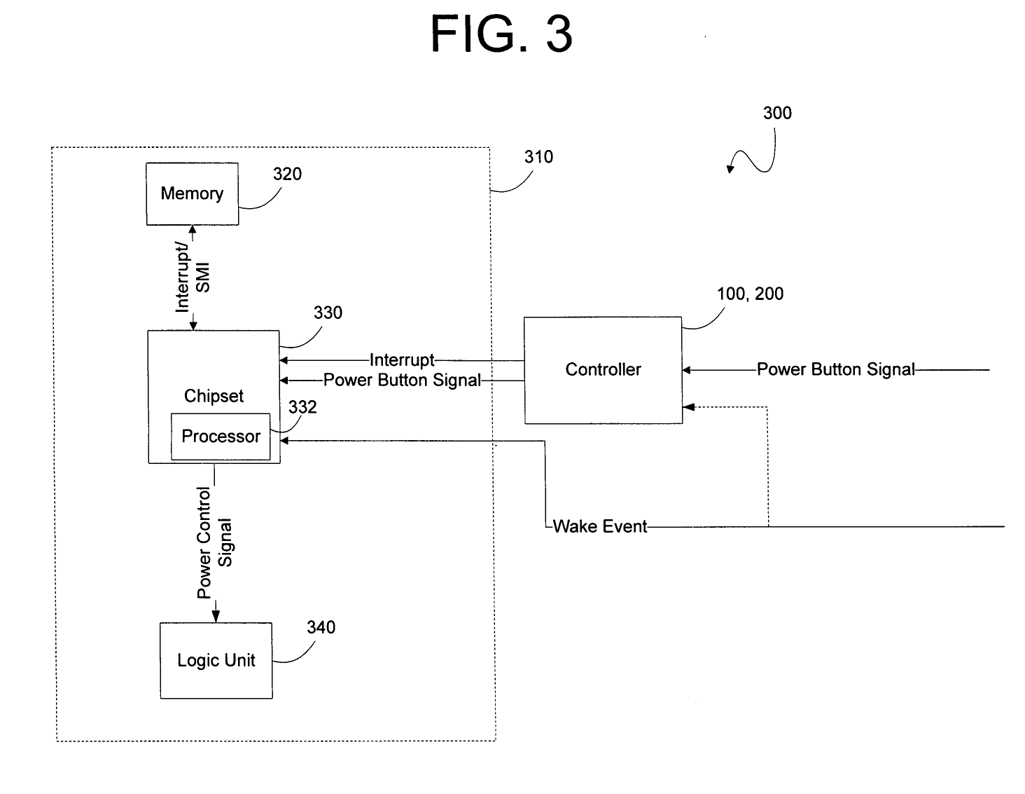

The control processor 110 is to generate and send an interrupt to a system if the continuous time period the power button signal is in the active state is greater than the controller time, the interrupt having higher priority than an operating system of the system. For example, the interrupt may cause the system to stop and/or to save its current state of execution for instructions relating to the operating system and instead execute instructions relating to the interrupt. The control processor 110 is to pass the power button signal to the system if the continuous time period the power button signal is in the active state is less than or equal to the controller time. For example, in FIG. 1, the control processor 110 is to transmit the interrupt if the received override signal is in the active state. An example system, the interrupt, the power button signal, and the controller time are explained in more detail in FIG. 3 below.

The power button 130 may be a physical button or other type of switch that is accessible by a user. For example, the power button 130 may be located on a front panel of a computing device, with the power button signal being in the active state only while the power button 130 is pressed. For instance, if the user were to hold or press down the power button 130 for four (4) seconds, the power button signal would be in the active state for 4 seconds. While the power button 130 is shown in FIG. 1 as a button or switch, embodiments of the power button 130 may also include other types of hardware triggers, such as signals related to a temperature or voltage state of the computing device.

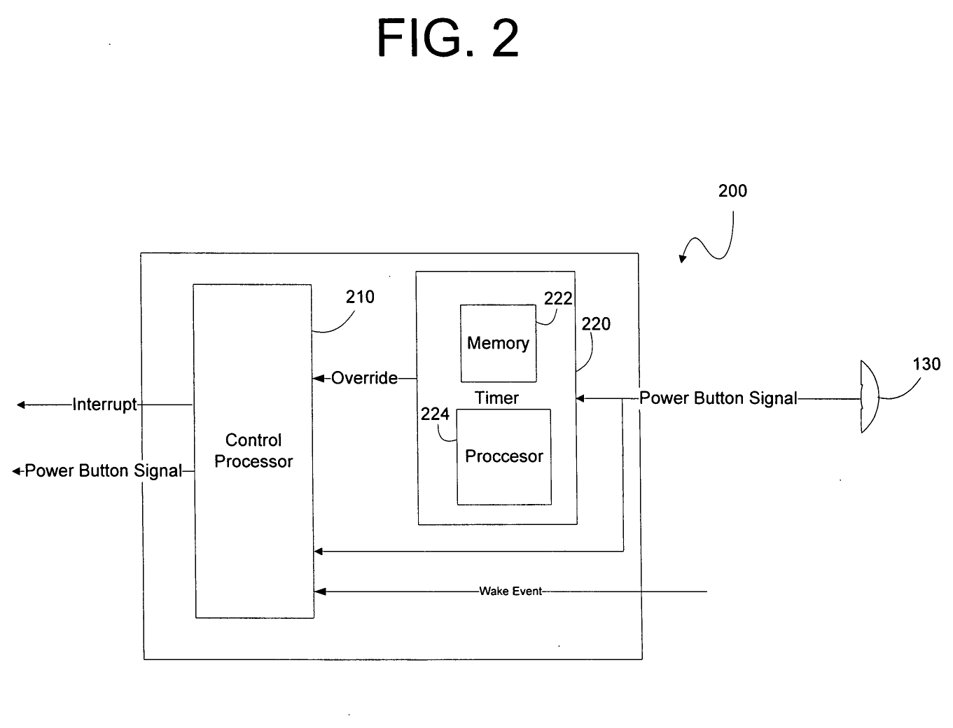

FIG. 2 is a block diagram of another example controller 200 to measure a continuous time period a power button signal is an active state. In the embodiment of FIG. 2, the controller 200 includes a control processor 210 and a timer 220. The controller 200 is to receive a power button signal from an external power button 130 and is to receive a wake event from an external source. The embodiment of FIG. 2 is similar to the embodiment of FIG. 1, except the controller 200 also receives the wake event.

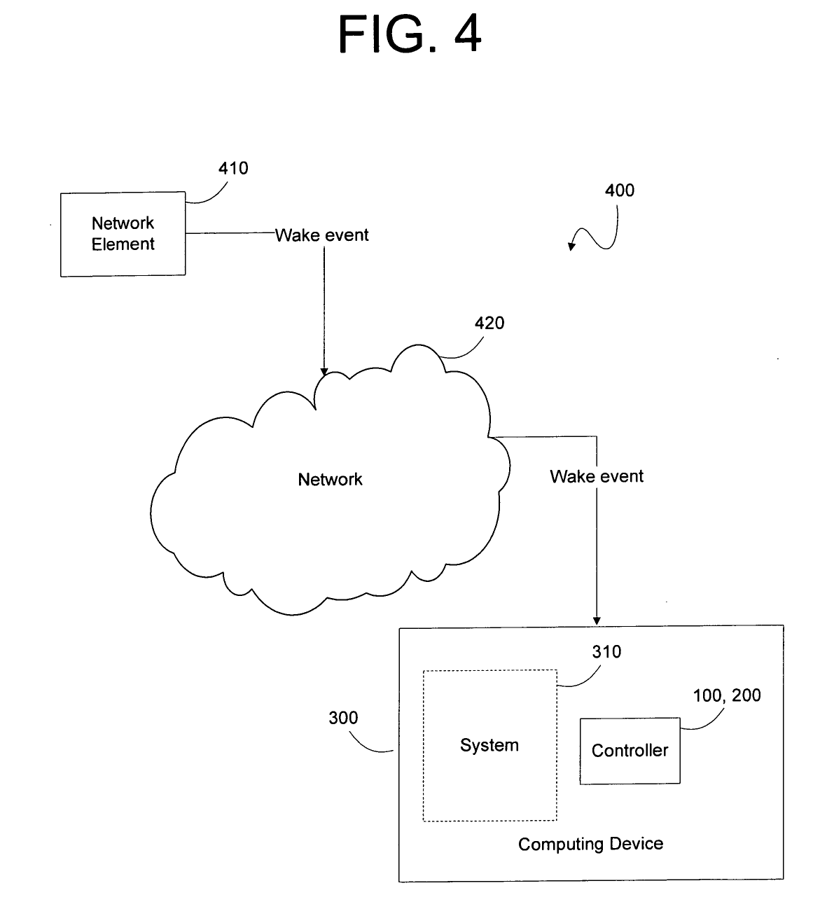

The control processor 210 of the controller 200 is to generate the power button signal in the active state and transmit the active power button signal to the system for a continuous time period less than a system time, if the control processor 210 receives the wake event. The wake event and the system time are explained in more detail in FIGS. 3 and 4 below.

FIG. 3 is a block diagram of an example computing device 300 including the controller 100 or 200 of FIG. 1 or 2. The computing device 300 further includes a memory 320, a chipset 330, and a logic unit 340. The system 310 may include the memory 320, the chipset 330, and the logic unit 340. The computing device 300 may be an electronic device including one or more computers, televisions, remote controlled devices, and the like.

The memory 320 may store a basic input/output system (BIOS) configured to output an instruction or System Management Interrupt (SMI) in response to the interrupt. The chipset 330 includes a processor 332 and is to enter a System Management Mode (SMM) in response to the instruction or SMI. For example, in the SMM, the chipset 330 may generate a power control signal to control power provided to the logic unit 340. While the chipset 330 is shown to include a single processor 332 and a single logic unit 340, the term processor 332 may also refer to a plurality of processors and the term logic unit 340 may also refer to a plurality of logic units. The one or more of the processors 332 may be configured to communicate with each other and/or interface with any of the logic units 340.

The logic unit 340 may include any type of device internal to the computing device 300 that requires a power source, such as components or expansion cards that may be connected to or included in the chipset 330. Some examples of these components or expansion cards may include a main memory, graphics controllers, peripheral buses such as PCI or ISA, integrated peripherals such as Ethernet, USB, audio devices, and the like.

The processor 332 included in the chipset 330 and the control processor 110 or 210 included in the controller 100 or 200 may be one or more central processing units (CPUs), semiconductor-based microprocessors, and/or other hardware devices suitable for retrieval and execution of instructions stored in the memory 122, 220 or 320.

The memory 122, 220 or 320 may be a machine-readable storage medium such as any electronic, magnetic, optical, or other physical storage device that contains or stores executable instructions. Thus, the memory 122, 220 or 320 may be, for example, Random Access Memory (RAM), an Electrically Erasable Programmable Read-Only Memory (EEPROM), a storage drive, a Compact Disc Read Only Memory (CD-ROM), and the like. The memory 122, 220 or 320 may store one or more applications executable by the processor 110, 210 or 332. For example, the memory 320 may include instructions for generating the SMI.

As shown in FIGS. 1-3, the control processor 100 or 200 is to selectively pass the power button signal and transmit the interrupt to the chipset 330. If the chipset 330 receives the power button signal in the active state for the continuous time period less than or equal to the system time, and the computing device 300 is already powered on, then the computing device 300 is not affected and will continue to operate normally. However, if the chipset 330 receives the power button signal in the active state for the continuous time period greater than the system time, the system 310 is to power down via the hardware shutdown and not be remotely woken. Thus, the chipset 330 is designed to not restart or power on the computing device 300 in response to a wake event after the hardware shutdown. This feature is generally implemented in the chipset 330 as a security precaution for when the computing device 300 is improperly shutdown. Instead, after the hardware shutdown, the chipset 330 will generally restart or power on the computing device 300 in response to the power button signal being in the active state.

Normally, the power button signal may only be in the active state if the user physically activates the power button 130, such as when the power button 130 that is located on the computing device 300 is physically pressed. However, as detailed in FIG. 2, the controller 200 is to generate and transmit the power button signal to the chipset 230 upon receiving the wake event. Therefore, in embodiments, the computing device 300 may be turned on or restarted in response to the wake event even after the hardware shutdown, if the computing device includes the controller 200 and transmits the wake event to the controller 200 (as shown by the dotted line).

The controller and system times may be varied or set according to a determined or desired time length, where the system time is greater than the controller time. Otherwise, if the system time was to be less than the controller time, the computing device 300 would begin the hardware shutdown before the controller 100 or 200 could generate the interrupt. Thus, for example, if the system time is 4 seconds, the controller time should be less than 4 seconds. The system time may be stored in the memory 320.

Upon receiving the interrupt, the chipset 330 is to forward the interrupt to the memory 320 via the processor 332. The interrupt may be identified by the chipset 330, for example, according to one or more bits included in the interrupt, such as control or address bits, or according to a port of the chipset 330 at which the interrupt is received. The BIOS included in the memory 320 may then trigger the SMI in response to the interrupt. For example, the SMI may instruct the chipset 330 to enter a different mode, such as the SMM, in which a relatively low-level handler routine is run to handle the SMI, where the SMI and its associated routine have a higher priority than an operating system of computing device 300. This interrupt service routine may direct the chipset 330 to, for example, ignore the power button signal, prevent the shutdown of the computing device 300, send an alert, initiate a sleep state, and the like. The actions of the interrupt service routine may be programmed according to a desired functionality. While FIG. 3 shows the memory 310 including the BIOS as generating the SMI, embodiments may include the SMI being generated by other components of the computing device 300.

The alert may be sent to an external entity, such as an operator, to provide notification that an attempt is being made to shutdown the computing device 300. The sleep state may refer to a low power state in which power consumption is reduced compared to a full on and idle state of the computing device 200. The sleep state may also allow the user or operator to save time by avoiding a full restart or reboot of the computing device 300. The sleep state may, for example, be a Suspend-To-RAM (STR) state, a Suspend-To-Disk (STD) state, or a Soft Off (SOFF) state. Context information used to wake from the sleep state may be stored in a volatile memory (not shown) of the system 310 in the STR state. The context information may be stored in a non-volatile memory (not shown) of the system 310 in the STD state, and the context information may not be stored in the SOFF state.

As shown in FIG. 3, only the controller 100 or 200 transmits the power button signal to the system. 310. Therefore, the controller 100 or 200 is able to control access of the power button signal by the system 310.

FIG. 4 is a block diagram of a network system 400 including the computing device 300 of FIG. 3. In the embodiment of FIG. 4, the network system 400 includes a network element 410, a network 420 and the computing device 300.

In FIG. 4, the computing device 300 is shown to be a desktop computer. However, embodiments of the computing device 300 may also include, for example, a notebook computer, an all-in-one system, a slate computing device, a portable reading device, a wireless email device, a mobile phone, and the like. Also, the network element 410 is shown to be a network server. However, embodiments of the network element 410 may include any type of device capable of transmitting a wake event, such as a modem, a network card, and the like.

The network element 410 is to send the wake event to the computing device 300 through the network 420, with the wake event to activate the computing device 300 from a sleep state or shutdown state. The network 420 may include one or more interconnected devices, such as network interface cards, repeaters, hubs, bridges, switches, routers, firewalls, and the like. The interconnected devices may share resources or information, such as the wake event.

The wake event may be a type of data or signal, such as a packet, sent to the chipset 330 and the controller 200. The wake event may be, for example, a Wake-On-Local Area Network (WOL) event, Wake-On-Ring (WOR) event, Peripheral Component Interconnect (PCI) Express event, or Legacy PCI Power Management Event (PME). The WOL event may be delivered through a network, while a WOR event may be delivered through a modem. The PCI Express event or Legacy PCI PME may be delivered from any type of peripheral device, such as a network interface controller (NIC). For example, assuming the computing device 300 is in a sleep state receptive to wake events, the wake event may be transmitted to a component of the chipset 330 that is powered on even when computing device 300 is in the sleep state and other components of the computing device 300 are powered down. In response to receiving the wake event, such a component may indicate to the computing device 300 to power on.

The wake event may be generated automatically or manually by the operator, where the operator may be an owner, licensor, licensee, or caretaker of the computing device 300, and the like. The user may be anyone using the computing device 300, such as a customer.

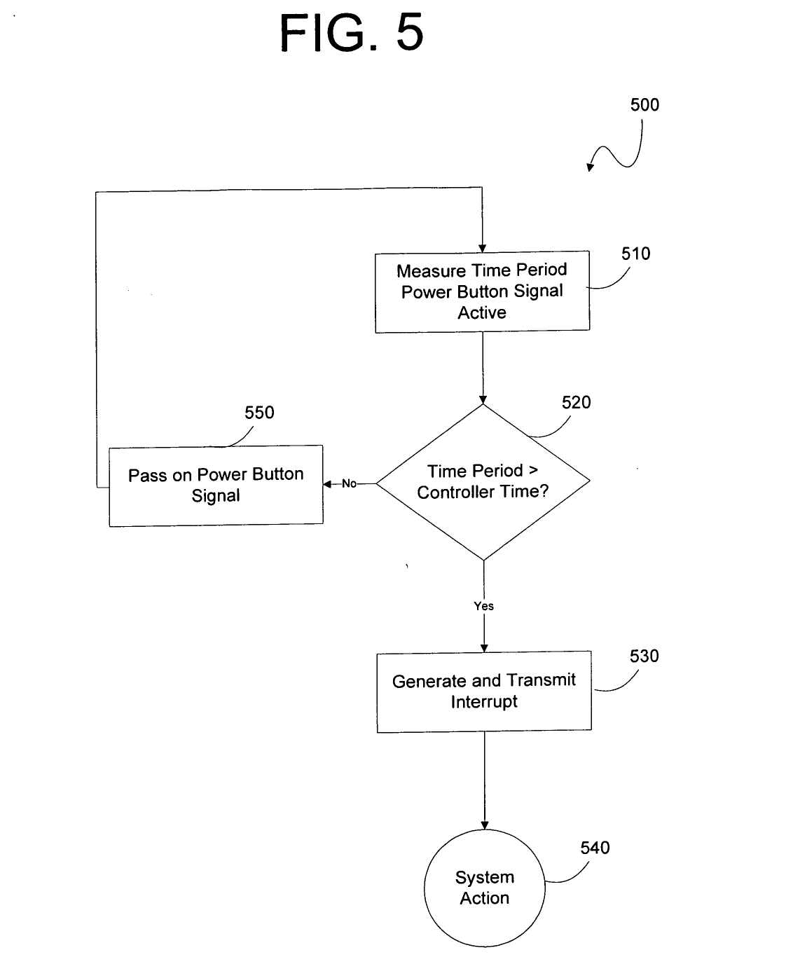

FIG. 5 is a flowchart of an example method 500 for measuring a continuous time period a power button signal is in the active state. Although execution of method 500 is described below with reference to the controller 100, other suitable components for execution of method 500 will be apparent to those of skill in the art (e.g., controller 200 or computing device 300). Method 500 may be implemented in the form of executable instructions stored on a machine-readable storage medium, such as the memory 122, 222 and/or 320, and/or in the form of electronic circuitry.

In the embodiment of FIG. 5, at block 510, the timer 120 measures the continuous time period the power button signal is in the active state. At block 520, the timer 120 compares the continuous time period to the controller time, which may be stored in the memory 122 of the timer 120. If the continuous time period is less than or equal to the controller time, then the method proceeds to block 550, where the timer 120 does not generate the override signal and the processor 110 passes on the power button signal to the system 310. Afterward, the method 500 returns to block 510.

If instead the continuous time period the power button signal is in the active state is greater than the controller time, then the method proceeds to block 530, where the timer 120 generates the override signal and the processor generates and transmits the interrupt to the system 310. Next, at step 540 the system 310 performs an action in response to receiving the interrupt. For example, as detailed above, the system 310 may ignore the power button signal, prevent the shutdown of the computing device 300, send an alert or initiate a sleep state.

In an embodiment, where the method 500 is implemented using the controller 200 of FIG. 2, the processor 210 may also monitor whether the wake event is received and then generate and transmit the power button signal for a time period less than system time, if the wake event is received.

According to the foregoing, embodiments disclosed herein measure a continuous time period a power button signal is in an active state. As a result, some embodiments at least allow a computing device associated with the power button signal to be restarted or powered on remotely, even after a user attempts a hardware shutdown of computing device. Some embodiments may also prevent the initiation of the hardware shutdown. As a result, an onsite visit to the remote computing device to restart the computing device can likely be avoided, thus at least reducing travel costs and time for an operator while also improving customer service.

We claim:

1. A controller, comprising:
a timer to measure a continuous time period a power button signal is in an active state, where the power button signal enters the active state when a power button is physically activated by a user to initiate a power down of a system; and
a control processor to generate and send an interrupt to the system if the continuous time period is greater than a controller time, the interrupt having higher priority than an operating system of the system.

2. The controller of claim 1, wherein the control processor is to pass the power button signal to the system if the continuous time period the power button signal is in the active state is less than or equal to the controller time.

3. The controller of claim 1, wherein the sent interrupt is to trigger the system into a system management mode (SMM) having higher priority than the operating system.

4. The controller of claim 3, wherein the sent interrupt is to configure the system to at least one of ignore the power button signal, prevent a power down of the system, send an alert, and initiate a sleep state.

5. The controller of claim 4, wherein,
the sleep state is at least one of a Suspend-To-RAM (STR) state, a Suspend-To-Disk (STD) state, and a Soft Off (SOFF) state,
context information used to wake from the sleep state is stored in a volatile memory of the system in the STR state,
the context information is stored in a non-volatile memory of the system in the STD state, and
the context information is not stored in the SOFF state.

6. The controller of claim 1, wherein,
the control processor is to generate and transmit the power button signal to the system for a continuous time period less than a system time, if the control processor receives a wake event, the wake event to power on the system, and
the system time is greater than the controller time.

7. The controller of claim 1, wherein,
the timer is to generate an override signal and transmit the override signal if the continuous time period is greater than the controller time, and
the control processor is to transmit the interrupt in response to the override signal.

8. A computing device, comprising:
a controller, including a control processor, to transmit an interrupt to a system if a continuous time period a power button signal is in an active state is greater than a controller time, the interrupt having higher priority than an operating system of the system, and the power button signal being in an the active state when a power button is physically activated by a user to initiate a power down of the system;
a memory, included in the system, storing a basic input/output system (BIOS) configured to output an instruction in response to the interrupt; and
a chipset, included in the system, to enter a system management mode (SMM) having higher priority than the operating system in response to the instruction.

9. The computing device of claim 8, wherein the chipset is to generate a power control signal based on the instruction output from the memory, the power control signal to control power provided to a logic unit of the computing device.

10. The computing device of claim 8, wherein the instruction is to configure the chipset to at least one of ignore the power button signal, prevent the power down of the system, send an alert, and initiate a sleep state.

11. The computing device of claim 8, wherein the control processor is to pass the power button signal to the chipset if the continuous time period the power button signal is in the active state is less than or equal to the controller time.

12. The computing device of claim 11, wherein,
the system is to power down and not be remotely woken if the chipset receives the power button signal in the active state for the continuous time period greater than a chipset time.
the system is to be remotely woken if the chipset receives the interrupt, and
the system time is greater than the controller time.

13. A network system, comprising:
the computing unit of claim 8; and
a network element configured to send a wake event to the computing device through a network, the wake event to power on the computing device.

14. The network system of claim 13, wherein the wake event is at least one of a Wake-On-Local Area Network (WOL), Wake-On-Ring (WOR), Peripheral Component Interconnect (PCI) Express, and Legacy PCI PME event.

15. The network system of claim 13, wherein,
the control processor is to generate and transmit the power button signal to the system for a continuous time period less than a system time, if the control processor receives the wake event, and
the system time is greater than the controller time.

16. A method, comprising:
measuring, using a timer, a continuous time period a power button signal is an active state, where the power button signal enters the active state when a power button is physically activated by a user to initiate a power down of a system;
generating, using a processor, an interrupt if the continuous time period is greater than a controller time; and
sending, using the processor, the interrupt to the system, the interrupt having higher priority than an operating system of the system.

17. The method of claim 16, further comprising:
passing the power button signal to the system if the continuous time period the power button signal is in the active state is less than or equal to the controller time.

18. The method of claim 16, further comprising:
generating and transmitting the power button signal to the system for a continuous time period less than a system time in response to a wake event, the wake event to power on the system, wherein
the system time is greater than the controller time.

19. The method of claim 16, wherein the sending the interrupt configures the system to at least one of ignore the SMI, prevent the power down of the system, send an alert, and initiate a sleep state.
